(19) United States
(12) Patent Application Publication
(10) Pub. No.: US 2021/0209120 A1
(43) Pub. Date: Jul. 8, 2021

(54) METHOD FOR UNSUPERVISED RANKING OF NUMERICAL OBSERVATIONS

(71) Applicant: University of Louisiana at Lafayette, Lafayette, LA (US)

(72) Inventors: Khalid A. Alattas, Lafayette, LA (US); Aminul Islam, Lafayette, LA (US); Ashok Kumar, Lafayette, LA (US); Magdy Bayoumi, Lafayette, LA (US)

(21) Appl. No.: 17/136,577

(22) Filed: Dec. 29, 2020

Related U.S. Application Data
(60) Provisional application No. 62/956,361, filed on Jan. 2, 2020.

(51) Int. Cl. G06F 16/2457; G06F 16/28

(52) U.S. Cl. CPC G06F 16/24578; G06F 16/285

(57) ABSTRACT

The inventive method, Unsupervised Ranking using Magnetic properties and Correlation coefficient (URMC) takes attributes of the dataset as inputs and returns a weight for each of the attributes in the dataset as output. URMC clusters the attributes into similar groups and updates the weight of attributes that can be used to rank the objects. The URMC algorithm assigns each attribute of a dataset to a positive or negative cluster with weights. This is done by using the correlation coefficients between all possible pairs of attributes. Initially, all the attributes are set in positive cluster with weight 0. If the correlation coefficient between two attributes is negative, it means that they should be in different clusters. Otherwise, they should be in the same positive cluster.

### CROSS REFERENCE TO RELATED APPLICATIONS

This application claims priority to U.S. Provisional Application No. 62/956,361 filed on Jan. 2, 2020 and entitled “Method for Unsupervised Ranking of Numerical Observations.”

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### SUMMARY OF INVENTION

This method provides a new algorithm that is drawn from magnetic properties. URMC algorithm cluster the attributes into two clusters based on magnetic sign and assigns each attribute a weight by using a correlation coefficient.

By using the magnetic properties, if the correlation coefficient between two attributes is positive, it means that they attract each other to be in the same cluster, otherwise they repulse each other to be in different clusters. Attribute weights are updated based on the sign of the weights of two compared attributes and the sign and value of the correlation coefficient between them.

Attribute weights are used to compute the ranking of the objects.

### DESCRIPTION OF THE DRAWINGS

The drawings constitute a part of this specification and include exemplary embodiments of the Method for Unsupervised Ranking of Numerical Observations, which may be embodied in various forms. It is to be understood that in some instances, various aspects of the invention may be shown exaggerated or enlarged to facilitate an understanding of the invention. Therefore the drawings may not be to scale.

FIG. 1 is a High-level depiction of the steps for unsupervised ranking of multi-attribute objects.

FIG. 2 depicts a URMC Algorithm.

FIG. 3 depicts a comprehensive overview of URMC algorithm.

FIG. 4 shows how attribute weights change using Algorithm 1 on the JR dataset with five attributes.

FIG. 5 shows how attribute weights change using Algorithm 1 on the JR dataset with eight attributes.

FIG. 6 shows how attribute weights change using Algorithm 1 on the Webometrics dataset.

FIG. 7 shows how attribute weights change using Algorithm 1 on the LQC dataset.

### BACKGROUND

With the rapid growth of the uses of information retrieval (IR) and social choice, ranking (or categorization) has become one of the key techniques for handling and organizing data. Ranking techniques are used to assign weights to the attributes of a specific dataset, to ultimately rank the objects in that dataset. This ranking helps any end user to make a decision on that dataset in a more efficient way. Ranking by hand is difficult, time-consuming, costly, and subjective, especially for a large dataset.

Ranking of multi-attribute objects are divided into two categories. The first category comes with completely labeled training data and uses supervised ranking algorithms. The second category, unsupervised ranking algorithms, is more challenging because no ground truth data is available. For multi-attribute objects, the majority of the datasets come with no ground truth dataset. This is because of the cost involved to create the ground truth dataset as well as the lack of any acceptable evaluation method.

Prior art concerning the unsupervised ranking of multi-attribute objects are primarily based on feature selection of attributes. Works based on feature selection of attributes use different techniques and rules to select the most important or relevant attributes for ranking. One of the main problems of feature selection on the current unsupervised ranking of multi-attribute objects is that each technique selects different attributes than others. However, removing some attributes from datasets is more challenging and could have an effect on the result of ranking.

The traditional approaches of unsupervised ranking use complex rules to rank multi-attribute objects. Moreover, some of the techniques of unsupervised ranking cannot deal with missing value fields. For example, ranking principal curve (RPC) algorithm requires full lists of attributes because it cannot process missing value attributes.

Unsupervised Ranking using Magnetic properties and Correlation coefficient (URMC) has the potential to rank multi-attribute objects using some (or all) of the attributes of a dataset. URMC also has the potential to address the problems of missing values in attributes by using correlation coefficient between attributes of a dataset. This is because correlation coefficient between attributes can be computed without much variation in the result even with some missing values in the attributes.

A correlation coefficient (r) has been a fundamental and efficient tool for data analysis and information retrieval by finding the strength measures of a linear association between two attributes and ranges between −1 (perfect negative correlation) to +1 (perfect positive correlation). URMC uses Pearson's correlation coefficient (r) as this is the most common measure of correlation and is used when the value of variables are continuous.

This method provides a new algorithm that is drawn from magnetic properties. URMC algorithm cluster the attributes into two clusters (i.e., positive and negative cluster) and place each attribute a weight by using Pearson (r) correlation. The idea of using magnetic properties is that if the correlation coefficient between two attributes is positive, it means that they attract each other to be in the same cluster, otherwise they repulse each other to be in different clusters. In later stage, attribute weights are used to compute the ranking of the objects.

This new method—a new URMC algorithm for unsupervised ranking of multi-attribute objects—provides at least the following advantages over the prior art. This algorithm uses magnetic properties and the correlation coefficient between each distinct pair of attributes to update the clusters and attribute weights of a dataset. The proposed algorithm can address all attributes, so there is no need to select relevant attributes and remove the irrelevant ones. The URMC algorithm assigns higher weight to relevant attributes and lower weight to irrelevant ones. URMC algorithm can handle missing value in the attributes.

Web search data is a common example of both supervised and unsupervised rank aggregation. Rank aggregation is to combine ranking results of attributes from multiple ranking functions in order to produce a better attribute. Supervised rank aggregation only considers the linear model of base rankers for aggregation function. Unsupervised ranking aggregation is widely used in the context of meta-search. It works by integrating the ranked list of documents returned by multiple search engine in response to a given query.

Unsupervised Learning Algorithm for Rank Aggregation (ULARA) is a common example of the framework of an unsupervised algorithm for rank aggregation based on permutations. The central idea of this method is that the large weights will be considered if the rank lists are closed to the average rank list, for each object. On the contrary, the smaller weights will be considered if the rank lists are quite different from the average rank list.

Normalized discounted cumulative gains (NDCG) and mean average precision (MAP) are extensively used in web search indicators to evaluate the supervised ranking performance which comprises the label of target ranking. TREC and LETOR are standards of existing supervised ranking methods. They focus on the search ranking symmetric with NDCG and MAP, which are evaluated on two datasets of query searching result.

Furthermore, most existing unsupervised ranking aggregation methods focus on search ranking such as PageRank algorithm. PageRank algorithm is the most famous unsupervised ranking which is used by Google™ Search to rank websites in the Google™ search engine outcome.

One issue with unsupervised ranking is how to provide a favorable ranking outcome since no ground truth label is available. For example, world universities, journals, sports, and countries datasets do not have target ranking available. This kind of ranking is referred to herein as ranking of multi-attribute objects.

Multi-Cluster Feature Selection (MCFS) and Multi-Cluster Feature Selection via Smooth Distributed Score (MCFS-SDS) are types of unsupervised ranking that use feature selection and work for clustering according to various studies, which show which attributes (features) should be selected, and which should be removed to perform ranking. These attributes which should be selected have some impact in ranking. While the attributes which should be removed are irrelevant. The attribute with a high value is considered relevant to ranking. According to spectral feature selection they describe, for both supervised and unsupervised, a framework of spectral feature selection and show the potential of selected feature (attribute).

Two well-known state-of-the-art unsupervised ranking algorithms are two-phase attribute ordering for unsupervised ranking and RPC. Two-phase attribute ordering for unsupervised ranking uses two phases. The first phase, Spearman Ranking Correlation Coefficients (SRCC), identifies irrelevant attributes that can adversely affect the ranking, and the second phase uses Extended Fourier Amplitude Sensitivity Test that presents the total effect for each attribute to ranking and then selects the attributes base on those phases. The idea is that the first phase distinguishes between attributes and identifies the irrelevant attributes by using two rules: strict monotonicity and smoothness. All attributes selected are considered as monotonically related to ranking. SRCC distinguishes between attributes to recognize irrelevant attributes before ranking to avert irrelevant attributes. The second phase is carried out from a reduced dataset to provide a quantity of important measure for each attribute. These methods address the attribute selection for unsupervised ranking tasks. But, for instance, the ranking of a journal would be higher if it has a higher citation. It is not wise to remove it as not important or irrelevant attribute

RPC proposed five meta-rules for unsupervised ranking which are scale and translation invariance, strict monotonicity, compatibility of linearity and nonlinearity, smoothness, and explicitness of parameter size. These five meta-rules are fundamental for RPC which is driven by PageRank. However, meta-rules are presented to evaluate the ranking models whether or not they are proper. RPC is a parametric design with a cubic Bezier' curve of strict monotonicity. Bezier' curve is a parametric curve frequently used in computer graphics that uses Bernstein polynomial as a basis to model a smooth curve and nonlinear regression. The five meta-rules are guidance for the ranking functions as constraints. RPC is visualized as graphical shapes. But, the greatest hurdle in using RPC is that it requires a full list of attributes because it process missing value fields and cannot work with partial lists.

### DETAILED DESCRIPTION

The subject matter of the present invention is described with specificity herein to meet statutory requirements. However, the description itself is not intended to necessarily limit the scope of claims.

This method provides a novel unsupervised algorithm to rank numerical observations which is important in many applications in computer science, especially in information retrieval (IR). The proposed algorithm shows how correlation coefficients between attribute values and the concept of magnetic properties can be used to rank multi-attribute numerical objects. One of the main reasons for using correlation coefficients between attribute values and the concept of magnetic properties is that they are easy to compute and interpret.

This Unsupervised Ranking using Magnetic properties and Correlation coefficient (URMC) algorithm can use some or all the numerical attributes of objects and can also process objects with missing attribute values. The proposed algorithm overcomes a major limitation of the state-of-the-art technique while achieving excellent results.

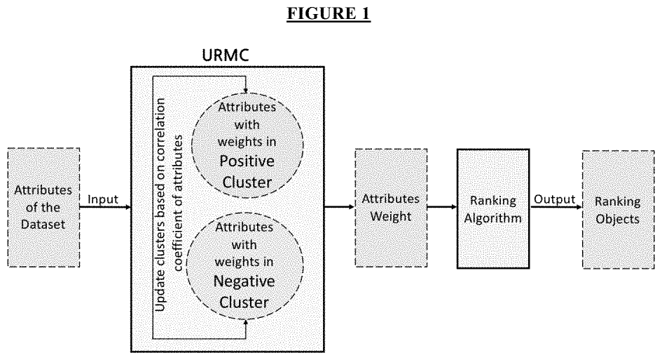

URMC takes attributes of the dataset as inputs and returns a weight for each of the attributes in the dataset as output. URMC clusters the attributes into similar groups and updates the weight of attributes that can be used to rank the objects. FIG. 1 depicts the high-level workflow of this approach. URMC algorithm takes attributes of a dataset and assigns each attribute to a positive or negative cluster with weights. This is done by using the correlation coefficients between all possible pairs of attributes. Initially, all the attributes are set in positive cluster with weight 0. If the correlation coefficient between two attributes is negative, it means that they should be in different clusters. Otherwise, they should be in the same positive cluster. The algorithm is described next.

Let X refer to a set of n objects, i.e., X=(x₁, x₂, . . . , xᵢ, . . . xₙ) and each of these objects have m number of attributes. Thus, an object xᵢ can be represented as a set of these attribute values, i.e., xᵢ=(aᵢ₁, aᵢ₂, . . . , aᵢⱼ, . . . aᵢₘ) where aᵢⱼ refers to the jth attribute value of object xᵢ. Again, let Aⱼ refer to the set of jth attribute values of all the n objects, i.e., Aⱼ=(a₁ⱼ, a₂ⱼ, . . . , aᵢⱼ, . . . aₙⱼ).

The first step of ranking is to normalize the datasets. Normalizing is one of the fundamental requirements of a ranking algorithm and has been referenced in the prior art. In general, the range of numerical values in each attribute of a dataset widely varies. For example, in one of the evaluation (or “example”) datasets (i.e., the journal ranking dataset), the attribute “Total Cites” ranges from 28851 to 105 and the attribute “Impact Factor” ranges from 9.256 to 0.176.

Thus, in one or more embodiments, an attribute value of an object is normalized into percentage using the following equation:

$${a}_{ij} = \frac{{a}_{ij}}{max {A}_{j}} \times 100 \qquad ( 1 )$$

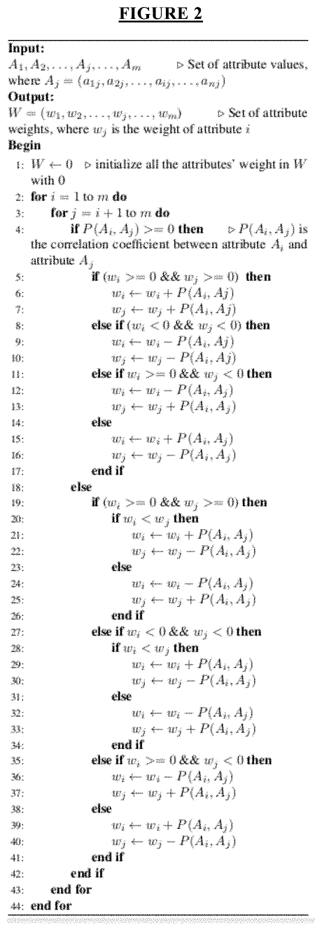

Algorithm 1 (FIG. 2) shows the pseudocode of URMC algorithm which is based on magnetic properties and correlation coefficient using Pearson (r) correlation to cluster the attributes into two clusters (i.e., positive and negative cluster of attributes) and set each attribute a weight. If the correlation coefficient is positive between two attributes, it signifies that they attract each other to be in the same cluster, otherwise they repel to be in different clusters. A comprehensive overview of URMC algorithm is shown in FIG. 2 which is divided into two parts: top part with positive correlation coefficient (i.e., P(Aᵢ, Aⱼ)≥0) and bottom part with negative correlation coefficient (i.e., P(Aᵢ, Aⱼ)≤0) between attributes, Aᵢ and Aⱼ.

Cells A to D represent the top part with positive correlation coefficient between the attributes (Lines 4-18, Algorithm 1 (FIG. 2)). Initially, all the attributes are set in positive cluster with weight 0. When two attributes are in the same cluster (either positive or negative), positive correlation coefficient between the two attributes means that they attract each other to be in the same cluster with more weights. But if the correlation coefficient between two attributes is positive and they are in different clusters, it means that they attract each other to bring the other in its own cluster.

Cell A shows that if attributes wi and wj are in the positive cluster and their correlation coefficient is positive, then they should be in the positive cluster and their weight will be updated by adding the correlation coefficient to their previous weights. This represents the concept that both attributes attract each other to be more positive if they were in the positive cluster and their correlation coefficient is positive (Line 6-8, Algorithm 1 (FIG. 2)).

Cell B shows that if attributes wi and wj are in the negative cluster and their correlation coefficient is positive, then they should be in the negative cluster and their weight will be updated by subtracting the correlation coefficient from their previous weights. This shows that both attributes attract each other to be more negative if they were in the negative cluster and their correlation coefficient is positive (Line 9-11, Algorithm 1 (FIG. 2)).

Cell C shows that if attribute wi is in the positive cluster and attribute wj is in the negative cluster and their correlation coefficient is positive, then wi attracts wj to be in the positive cluster and wj attracts wi to be in the negative cluster. Thus, the weight of wi will be updated by subtracting the correlation coefficient from its previous weight. And the weight of wj will be updated by adding the correlation coefficient to its previous weight (Line 12-14, Algorithm 1 (FIG. 2)).

Cell D shows that if attribute wi is in the negative cluster and attribute wj is in the positive cluster and their correlation coefficient is positive, then wi attracts wj to be in the negative cluster and wj attracts wi to be in the positive cluster. Thus, the weight of wi will be updated by adding the correlation coefficient to its previous weight. And the weight of wj will be updated by subtracting the correlation coefficient from its previous weight (Line 15-17, Algorithm 1).

On the other hand, cells E to J represent the bottom part with negative correlation coefficient between the attributes (Line 20-41, Algorithm 1). In this part, since the correlation coefficient between two attributes is negative, it means that the two attributes repulse each other to be in different clusters.

Here, cell E shows that if attributes wi and wj are in the positive cluster and the weight of wi is less than the weight of wj (i.e., wi<wj) and their correlation coefficient is negative, then wi and wj repulse each other to be in different clusters. Thus, the weight of wi will be updated by adding the correlation coefficient to its previous weight. As the correlation coefficient is negative, adding it to the previous weight of wi will shift wi towards the negative cluster. And the weight of wj will be updated by subtracting the correlation coefficient from its previous weight. Again, as the correlation coefficient is negative, subtracting it from the previous weight of wj will move wj towards more positive side (Line 21-23, Algorithm 1).

Cell F shows that if attributes wi and wj are in the positive cluster and the weight of wi is greater than or equal to the weight of wj (i.e., wi>wj) and their correlation coefficient is negative, then wi and wj repulse each other to be in different clusters. Thus, the weight of wi will be updated by subtracting the correlation coefficient from its previous weight. And the weight of wj will be updated by adding the correlation coefficient to its previous weight (Line 24-26, Algorithm 1).

Cell G shows that if attributes wi and wj are in the negative cluster and the weight of wi is less than the weight of wj (i.e., wi<wj) and their correlation coefficient is negative, then wi and wj repulse each other to be in different clusters. Thus, the weight of wi will be updated by adding the correlation coefficient to its previous weight. And the weight of wj will be updated by subtracting the correlation coefficient from its previous weight (Line 28-31, Algorithm 1).

Cell H shows that if attributes wi and wj are in the negative cluster and the weight of wi is greater than or equal to the weight of wj (i.e., wi>=wj) and their correlation coefficient is negative, then wi and wj repulse each other to be in different clusters. Thus, the weight of wi will be updated by subtracting the correlation coefficient from its previous weight. And the weight of wj will be updated by adding the correlation coefficient to its previous weight (Line 32-34, Algorithm 1).

Cell I shows that if attribute wi is in the positive cluster and attribute wj is in the negative cluster and their correlation coefficient is negative, then wi and wj repulse each other to be in different cluster. Thus, the weight of wi will be updated by subtracting the negative correlation coefficient from its previous weight. And the weight of wj will be updated by adding the correlation coefficient to its previous weight (Line 36-38, Algorithm 1). It means that wi and wj will move towards more positive and more negative side of the cluster, respectively.

Cell J shows that if attribute wi is in the negative cluster and attribute wj is in the positive cluster and their correlation coefficient is negative, then wi and wj repulse each other to be in different cluster. Thus, the weight of wi will be updated by adding the negative correlation coefficient to its previous weight. The weight of wj will be updated by subtracting the negative correlation coefficient from its previous weight (Line 39-41, Algorithm 1). It means that wi and wj will move towards more negative and more positive side of the cluster, respectively.

An object xᵢ can be represented as a set of attribute values, i.e., xᵢ=(aᵢ₁, aᵢ₂, . . . , aᵢⱼ, . . . aᵢₘ), where aᵢⱼ refers to the jth attribute value of object xᵢ. Again the output of the URMC algorithm are the weights of each of the m attributes, i.e., W=(w₁, w₂, . . . , wⱼ, . . . , wₘ), where wⱼ is the weight of attribute j. Based on these notations, the ranking score is computed (referred to herein as the “URMC score”) of an object xᵢ using the following equation:

URMC score of xᵢ=w₁×aᵢ₁+w₂x aᵢ₂+ . . . +wⱼ×aᵢⱼ . . . +wₘ×aᵢₘ (2).

Based on Equation 2, compute the URMC scores for all the n objects and sort the objects by these scores in descending order to get the ranking order of the objects.

In one or more embodiments, the URMC is used to rank numerical multi-attribute objects. In other embodiments, the URMC is used to be to rank numerical and nonnumerical multi-attribute objects (i.e., text). For the nonnumerical attribute objects, the objects are first converted from texts into their representative numerical values.

In one or more embodiments, the URMC can be used to perform intra-attribute weight analysis by analyzing the attribute values without comparing the attribute with other attributes

### Example 1

Suppose we have eight countries (i.e., objects) with four attributes which include gross domestic product (GDP), life expectancy at birth (LEB), infant mortality rate (IMR), and tuberculosis (Tub) as shown in Table 1 (This is part of one of the evaluation datasets called Life Qualities of Countries (LQC) dataset).

TABLE 1
Life Quality of 8 Countries

| Country | GDP | LEB | IMR | Tub |
|---|---|---|---|---|
| Finland | 30469 | 79.09 | 3 | 3 |
| France | 29644 | 80.47 | 6 | 4 |
| Germany | 30496 | 79.48 | 3 | 4 |
| Ireland | 38058 | 79.4 | 6 | 4 |
| Italy | 27750 | 81.18 | 3 | 4 |
| Spain | 27270 | 80.28 | 13 | 4 |
| UK | 31580 | 79.3 | 6 | 5 |
| USA | 41674 | 77.93 | 2 | 7\| |

The first step of ranking is to normalize the dataset so that they are in the same quantity dimensions based on Equation 1. The results of the normalization are shown in Table 2.

TABLE 2
Percentage normalized

| Country | GDP | LEB | IMR | Tub |
|---|---|---|---|---|
| Finland | 73.11 | 97.43 | 23.08 | 42.86 |
| France | 71.13 | 99.13 | 46.15 | 57.14 |
| Germany | 73.18 | 97.91 | 23.08 | 57.14 |
| Ireland | 91.32 | 97.81 | 46.15 | 57.14 |
| Italy | 66.59 | 100 | 23.08 | 57.14 |
| Spain | 65.44 | 98.89 | 100 | 57.14 |
| UK | 75.78 | 97.68 | 46.15 | 71.43 |
| USA | 100 | 96 | 15.38 | 100 |

In the URMC algorithm, use Pearson's correlation coefficients (r) between attributes shown in Table 3.

TABLE 3
Pearson's correlation coefficient between attributes

| Attribute | GDP | LEB | IMR | Tub |
|---|---|---|---|---|
| GDP | 1.00 | −0.80 | −0.39 | 0.70 |
| LEB | −0.80 | 1.00 | 0.36 | −0.60 |
| IMR | −0.39 | 0.36 | 1.00 | −0.23 |
| Tub | 0.70 | −0.60 | −0.23 | 1.00 |

The next step of URMC algorithm is to compute the weight of each attribute (shown in Table 4).

TABLE 4
Weight of the attributes

| Attribute | Weight of attributes |
|---|---|
| GDP | 1.90 |
| LEB | −1.76 |
| IMR | −0.99 |
| Tub | 1.53 |

For example, to compute the weight of GDP, Algorithm 1 do the following:

Initially, GDP is set in the positive cluster with weight 0. As cell F in FIG. 2 shows that if attributes GDP and LEB are in the positive cluster and the weight of GDP is equal to that of LEB and their correlation coefficient is negative (i.e., −0.80), then GDP and LEB repulse each other to be in different clusters. Thus, the weight of GDP will be updated by subtracting the correlation coefficient of GDP with LEB from its previous weight (i.e., GDP=0−(−0.80)=0.80).

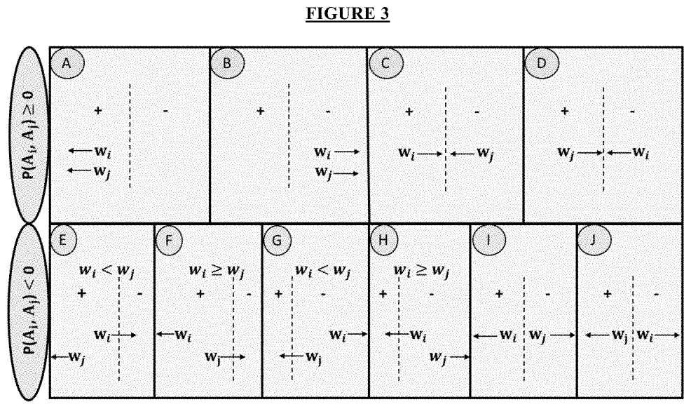

Again, both GDP (with weight 0.80) and IMR (with initial weight 0) are in the positive cluster, the weight of GDP is greater than that of IMR and their correlation coefficient is negative (i.e., −0.39) means that Algorithm 1 (FIG. 2) will use the computation of cell F in FIG. 3. Thus, the weight of GDP will be updated by subtracting the correlation coefficient of GDP with IMR from its previous weight (i.e., GDP=0.80−(−0.39)=1.2).

Finally, as cell A in FIG. 3 shows that if attributes GDP (with weight 1.2) and Tub (with initial weight are in the positive cluster and their correlation coefficient is positive (i.e., 0.70), then GDP and Tub attract each other to be in the same cluster with more weight. Thus, the weight of GDP will be updated by adding the correlation coefficient of GDP with Tub to its previous weight (i.e., GDP=1.2+(0.70)=1.9).

Next, compute the ranking scores (i.e., URMC scores) for all the eight countries using Equation 2. For example, the ranking score of Finland using Equation 2, Table 2 and 4 can be computed as follows:

Ranking score of Finland=(weight of GDP×Percentage of GDP for Finland)+(weight of LEB×percentage of LEB for Finland)+(weight of IMR×percentage of JMR for Finland)+(weight of Tub×percentage of Tub for Finland)=(1.90×73.11)+(−1.76×97.43)+(−0.99×23.08)+(1.53×42.86)=10.16.

Sorting the eight countries by these ranking scores in descending order will be the ranking order of the eight countries as shown in Table 5.

TABLE 5
Ranking result of the eight countries

| Country | URMC Score | URMC Order |
|---|---|---|
| USA | 158.97 | 1 |
| Ireland | 43.56 | 2 |
| UK | 36.13 | 3 |
| Germany | 31.52 | 4 |
| Italy | 15.33 | 5 |
| Finland | 10.16 | 6 |
| France | 2.87 | 7 |
| Spain | −60.28 | 8 |

### Example 2

To evaluate and compare this inventive algorithm to the RPC algorithm, one of the state-of-the-art algorithms on the task, use the following three datasets: Journals, Webometrics, and Life Qualities of Countries (LQC). RPC algorithm also used these datasets to evaluate their algorithm.

This dataset presents data about academic journals in the sciences and social sciences and is available from the Web of Knowledge 2 which is associated with Thomson Reuters. RPC algorithm used JCR2012 version of this dataset. Though this dataset has eight attributes, authors of the RPC algorithm select only five out of the eight attributes to rank the journals.

This example compares URMC with RPC in two different settings. First, it compares URMC with RPC using only the five attributes selected by RPC. Second, it uses all the eight attributes provided in the main dataset to see how URMC does without selecting attributes compared to RPC with selected attributes.

The Pearson correlation coefficients between URMC's and RPC's ranking orders and scores are 0.9987 and 0.9829, respectively. As there is no ground truth for this dataset, these very strong correlation coefficients show that URMC is very comparable with RPC. In Table 6, we show the top and the bottom five journals out of the 393 journals with five attributes ranked by URMC and their corresponding ranking by RPC on this dataset.

TABLE 6

| | Attributes | | | | | | | | |
|---|---|---|---|---|---|---|---|---|---|
| | | 5 -year | | | | | | | |
| | Impact | Impact | Immediacy | Eigenfactor | Influence | RPC | | URMC | |
| Journal Title | Factor | Factor | Index | Score | Score | Score | Order | Score | Order |
| IEEE T PATTERN ANAL | 4.795 | 6.144 | 0.625 | 0.05237 | 3.235 | 1 | 1 | 705.6233 | 1 |
| ENTERP INF SYST UK | 9.256 | 4.771 | 2.682 | 0.00173 | 0.907 | 0.95051 | 2 | 638.1533 | 2 |
| MIS QUART | 4.659 | 7.474 | 0.705 | 0.01036 | 3.077 | 0.91046 | 4 | 631.9720 | 3 |
| J STAT SOFTW | 4.91 | 5.907 | 0.753 | 0.01744 | 3.314 | 0.91622 | 3 | 623.7083 | 4 |
| ACM COMPUT SURV | 3.543 | 7.854 | 0.421 | 0.0064 | 4.097 | 0.90923 | 5 | 612.8080 | 5 |
| . | . | . | . | . | . | . | . | . | . |
| . | . | . | . | . | . | . | . | . | . |
| . | . | . | . | . | . | . | . | . | . |
| NEURAL NETW WORLD | 0.362 | 0.381 | 0.029 | 0.00033 | 0.082 | 0.00685 | 389 | 30.2121 | 389 |
| J INF SCI ENG | 0.299 | 0.326 | 0.03 | 0.00095 | 0.088 | 0.00625 | 390 | 28.7437 | 390 |
| INT J SOFTW ENG KNOW | 0.295 | 0.336 | 0.03 | 0.00044 | 0.107 | 0.00550 | 391 | 28.5385 | 391 |
| J COMPUT SYS SC INT | 0.249 | 0.242 | 0.078 | 0.00066 | 0.08 | 0.00104 | 392 | 26.1747 | 392 |
| COMPUT INFORM | 0.254 | 0.305 | 0.06 | 0.00031 | 0.065 | 0.00000 | 393 | 25.5589 | 393 |

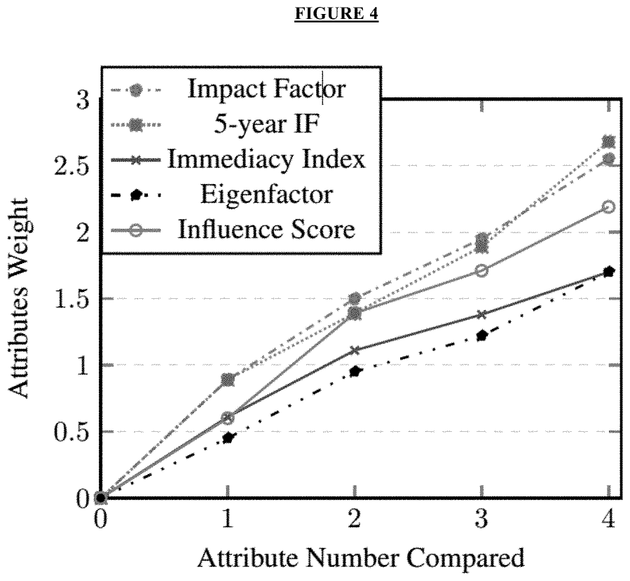

FIG. 4 shows how attribute weights significance change when attributes are compared with each other using Algorithm 1 (FIG. 2). Initially, weights of all the attributes are set to 0. Numbers on the x-axis represent the attribute that is compared with the rest of the attributes. For example, 1 on the x-axis shows the weights of the attributes after comparing attribute one with the rest four attributes. Similarly, 2 on the x-axis shows the weights of the attributes after comparing attribute two with the rest three attributes, and so on. All these procedures are significant because they show the distinctiveness between attributes and how the weights get more spread or separated by each step. The Pearson correlation coefficient represents either the strength or weakness of the relationship between two attributes. URMC significantly (T-test, the p-value is <0.00001) outperforms RPC on JR dataset with five attributes.

The Pearson correlation coefficients between URMC's and RPC's ranking orders and scores are 0.9805 and 0.9776, respectively. Here, RPC uses only the five selected attributes. These very strong correlations indicate that URMC's ranking, without selecting any attribute, is comparable to that of RPC which uses only the selected attributes. In Table 7, we show the top and the bottom five journals out of the 393 journals ranked by URMC (with all the eight attributes) and their corresponding ranking by RPC (with five selected attributes, underlined) on this dataset.

TABLE 7

| | Attributes | | | | | | | | | | | |
|---|---|---|---|---|---|---|---|---|---|---|---|---|
| | | | 5-Year | | | Cited | | | RPC with 5 | | URMC with 8 | |
| | Total | Impact | Impact | Immediacy | | Half- | Eigenfactor | Influence | Attributes | | Attributes | |
| Journal Title | Cites | Factor | Factor | Index | Articles | life | Score | Score | Score | Order | Score | Order |
| IEEE T PATTERN | 24947 | 4.795 | 6.144 | 0.625 | 192 | 10 | 0.00054 | 3.235 | 1 | 1 | 786.8565 | 1 |
| ANAL | | | | | | | | | | | | |
| MIS QUART | 7277 | 4.659 | 7.474 | 0.705 | 61 | 4.5 | 0.00324 | 3.077 | 0.91046 | 4 | 697.4675 | 2 |
| ENTERP INF SYST | 579 | 9.256 | 4.771 | 2.682 | 22 | 4.5 | 0.00459 | 0.907 | 0.95051 | 2 | 693.6994 | 3 |
| UK | | | | | | | | | | | | |
| ACM COMPUT SURV | 2907 | 3.543 | 7.854 | 0.421 | 38 | 9.6 | 0.0064 | 4.097 | 0.90923 | 5 | 652.7896 | 4 |
| J STAT SOFTW | 2629 | 4.91 | 5.907 | 0.753 | 77 | 5 | 0.00005 | 3.314 | 0.91622 | 3 | 646.3808 | 5 |
| . | . | . | . | . | . | . | . | . | . | . | . | . |
| . | . | . | . | . | . | . | . | . | . | . | . | . |
| . | . | . | . | . | . | . | . | . | . | . | . | . |
| ADV COMPUT | 152 | 0.389 | 0.452 | 0.043 | 23 | 9.6 | 0.00029 | 0.195 | 0.02148 | 275 | 1.9415 | 389 |
| PROBL INFORM | 445 | 0.298 | 0.387 | 0.062 | 32 | 10 | 0.04144 | 0.264 | 0.02497 | 371 | 1.7215 | 390 |
| TRANSM | | | | | | | | | | | | |
| INT J COMPUT | 215 | 0.176 | 0.253 | 0 | 22 | 7.4 | 0.00427 | 0.272 | 0.01233 | 386 | −0.3940 | 391 |
| GEOM AP | | | | | | | | | | | | |
| J EXP THEOR | 182 | 0.317 | 0.57 | 0 | 29 | 10 | 0.00201 | 0.186 | 0.02159 | 374 | −0.4197 | 392 |
| ARTIF IN | | | | | | | | | | | | |
| INT J ARTIF | 263 | 0.25 | 0.453 | 0.054 | 56 | 10 | 0.00062 | 0.174 | 0.01809 | 380 | −0.6728 | 393 |
| INTELL T | | | | | | | | | | | | |

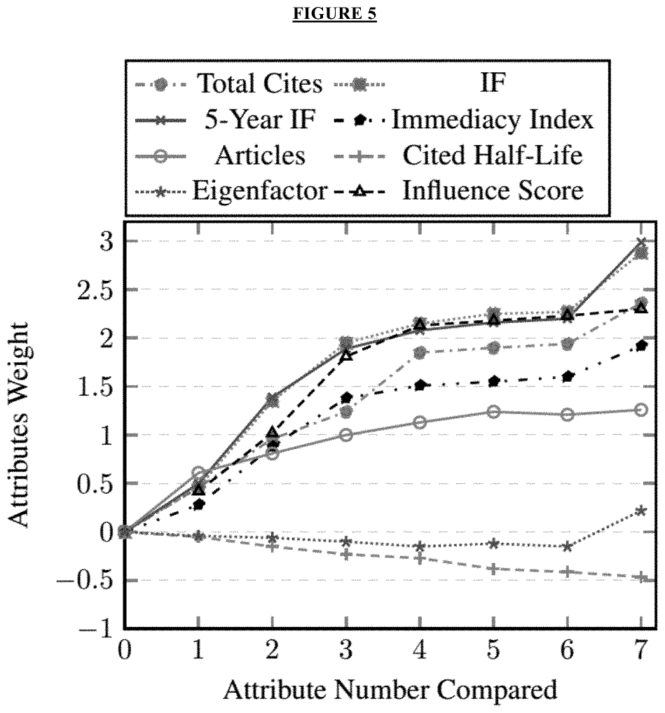

FIG. 5 shows how attribute weights change when attributes are compared with each other using Algorithm 1. FIG. 5 also shows that as the number of attributes compared with increases, from one (1) to seven (7), the weight of each attribute gets more distinctive. Furthermore, “Cited Half-life”, one of the eight attributes of the main dataset used by URMC algorithm, has 16 missing values. The very strong correlation coefficients between URMC's and RPC's ranking orders and scores suggest that URMC algorithm is effective even with missing value attributes. URMC significantly (T-test, the p-value is <0.00001) outperforms RPC on JR dataset with eight attributes.

The second dataset tested presents data about the top 500 world universities and is available from the Webometrics Ranking of World Universities which is associated with Cybermetrics Lab, a research group belonging to the Consejo Superior de Investigaciones Cient'ificas (CSIC), the largest public research body in Spain.

As this dataset provides a ranking order, this example compares URMC with this ranking order as well as with RPC.

The Pearson correlation coefficients between URMC's and RPC's ranking orders and scores are 0.9704 and 0.9768, respectively. Again, these very strong correlation coefficients show that URMC is very comparable with RPC.

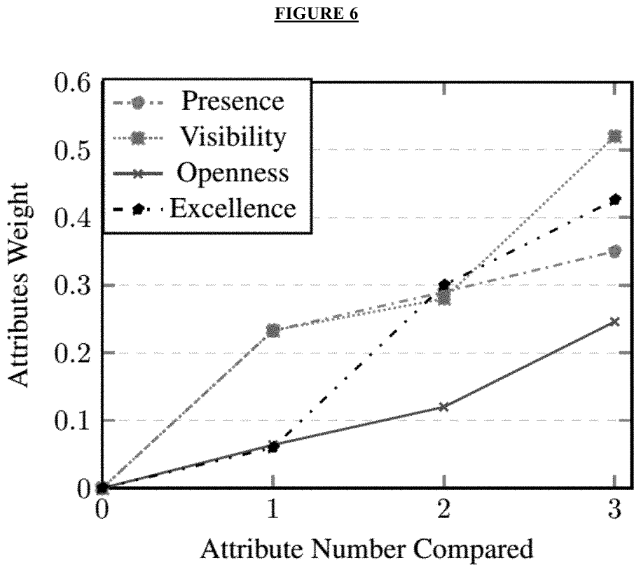

In Table 8, the dataset shows the top and the bottom five universities out of 500 world universities ranked by URMC and their corresponding ranking by RPC and Webometrics. FIG. 6 shows how attribute weights change when attributes are compared with each other using Algorithm 1. The Pearson correlation coefficient between URMC's and Webometrics' ranking orders is 0.87. Again, the Pearson correlation coefficient between RPC's and Webometrics' ranking orders is 0.89, which shows that URMC is comparable to RPC based on Webometrics' ranking orders.

TABLE 8

| | Attributes | | | | RPC | | Webometrics | URMC | |
|---|---|---|---|---|---|---|---|---|---|
| University Name | Presence | Visibility | Openness | Excellence | Score | Order | Order | Score | Order |
| Massachusetts Institute of Technology | 1559 | 1466 | 678 | 28 | 0.98357 | 2 | 3 | 457.2426 | 1 |
| University of Illinois Urbana Champaign | 1587 | 1060 | 85 | 369 | 0.88908 | 7 | 20 | 371.6282 | 2 |
| Harvard University | 1573 | 734 | 1074 | 138 | 0.91362 | 4 | 1 | 349.9087 | 3 |
| University of British Columbia | 1091 | 1132 | 159 | 377 | 0.82897 | 25 | 22 | 349.4531 | 4 |
| Stanford University | 1559 | 124 | 1667 | 774 | 1.00 | 1 | 2 | 337.9593 | 5 |
| . | . | . | . | . | . | . | . | . | . |
| . | . | . | . | . | . | . | . | . | . |
| . | . | . | . | . | . | . | . | . | . |
| Nankai University | 2 | 11 | 122 | 7 | 0.01270 | 498 | 433 | 10.3521 | 496 |
| University Politechnica of Bucharest | 25 | 8 | 91 | 5 | 0.01573 | 496 | 490 | 9.6224 | 497 |
| Cardiff University | 51 | 1 | 1 | 1 | 0.01286 | 497 | 484 | 4.5788 | 498 |
| Universitss Paris | 5 | 3 | 30 | 10 | 0.00254 | 499 | 500 | 3.6348 | 499 |
| Wright State University | 1 | 1 | 25 | 3 | 0.00 | 500 | 460 | 2.0516 | 500 |

A third dataset examined presents data about life qualities of countries and is available from GAPMINDER. RPC used a fraction of this dataset to rank 171 countries based on four attributes which include life expectancy at gross domestic product (GDP), life expectancy at birth (LEB), infant mortality rate (IMR), and tuberculosis (Tub). To fairly compare with RPC, this examples uses the same fraction of the dataset and attributes mentioned.

The Pearson correlation coefficients between URMC's and RPC's ranking orders and scores are 0.9976 and 0.9897, respectively. These very strong correlation coefficients indicate that URMC's ranking is strongly comparable to that of RPC.

Table 9 shows the top and the bottom five countries out of the 171 countries ranked by URMC and their corresponding ranking by RPC on this dataset.

TABLE 9

| | Attributes | | | | RPC | | URMC | |
|---|---|---|---|---|---|---|---|---|
| Country | GDP | LEB | IMR | Tuberculosis | Score | Order | Score | Order |
| Luxembourg | 70014 | 79.56 | 6 | 4 | 1 | 1 | 391.2335 | 1 |
| Norway | 47551 | 80.29 | 3 | 3 | 0.89098 | 2 | 341.5337 | 2 |
| Singapore | 41479 | 79.627 | 12 | 2 | 0.85184 | 4 | 322.0661 | 3 |
| Iceland | 35630 | 81.43 | 2 | 2 | 0.81824 | 7 | 317.6761 | 4 |
| United States of American | 41674 | 77.93 | 2 | 7 | 0.84922 | 5 | 315.6420 | 5 |
| . | . | . | . | . | . | . | . | . |
| . | . | . | . | . | . | . | . | . |
| . | . | . | . | . | . | . | . | . |
| Congo, Dem. Rep. | 330 | 47.629 | 183 | 129 | 0.17951 | 163 | −116.6396 | 167 |
| Angola | 3533 | 45.523 | 119 | 154 | 0.19208 | 162 | −118.5150 | 168 |
| Afghanistan | 874 | 42.88 | 76 | 165 | 0.19725 | 161 | −127.3279 | 169 |
| Sierra Leone | 790 | 46.365 | 219 | 160 | 0.12698 | 168 | −176.7179 | 170 |
| Swaziland | 4384 | 44.99 | 422 | 110 | 0.00000 | 171 | −199.3435 | 171 |

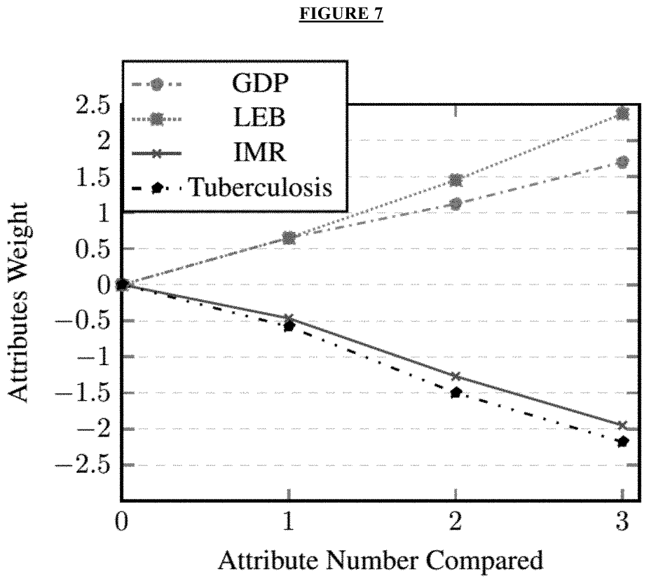

FIG. 7 shows how attribute weights change when attributes are compared with each other using Algorithm. The figure also shows that as the number of attributes compared with increases, from one (1) to three (3), the weight of each attribute gets more distinctive. URMC significantly (T-test, the p-value is <0.00001) outperforms RPC on LQS dataset.

This invention provides an unsupervised ranking algorithm for multi-attribute numerical objects by incorporating correlation coefficients between attribute values using the concept of magnetic properties.

The algorithm computes more distinctive weights for attributes to rank the objects. Unlike other algorithms, the URMC algorithm can process an objects' missing attribute values. URMC, which does not select attributes, is comparable to the algorithm that selects some important attributes to rank multi-attribute numerical objects. Experimental results on three different datasets confirmed that URMC is strongly comparable to state-of-the-art unsupervised ranking algorithms that cannot deal with attributes with missing values and needs to select attributes before ranking.

For the purpose of understanding the Method for Unsupervised Ranking of Numerical Observations, references are made in the text to exemplary embodiments of an Method for Unsupervised Ranking of Numerical Observations, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

1. A method for unsupervised ranking based on magnetic properties comprising:
a. identifying a correlation coefficient;
b. identifying a plurality of attributes;
c. applying a weight to each of said attributes; and
d. clustering said attributes based on said correlation coefficient.

2. The method of claim 1 wherein said correlation coefficient comprises the Pearson correlation.

3. The method of claim 1 wherein said clustering step comprises clustering said attributes into two clusters, one of said two clusters consisting of positives and one of said two clusters consisting of negatives.

4. The method of claim 1 wherein said clustering step further comprises determining if said correlation coefficient is positive between any at least two said attributes.

5. The method of claim 1 wherein said attributes consists of relevant attributes and irrelevant attributes.

6. The method of claim 5 wherein said identifying a plurality of attributes, applying, and clustering steps are performed on both said relevant attributes and said irrelevant attributes.

7. A method for determining weight values of attributes based on magnetic properties comprising:
a. normalizing a first attribute value of an object and normalizing a second attribute value of said object;
b. assigning a weight to each of said normalized attribute values to obtain a first weight and a second weight;
c. updating said first weight and said second weight based on the sign of the correlation coefficient between said first weight and said second weight, and based on the sign of said first weight and the sign of said second weight to determine an updated first weight and an updated second weight;
wherein in said updating step, when the sign of said first weight and the sign of said second weight is the same, and when said correlation coefficient is positive between said first weight and said second weight, an amount equal to said correlation coefficient between said first weight and said second weight is added to both said first weight and said second weight;
wherein in said updating step, when the sign of one of said first weight and second weight is positive and the sign of the other of said second weight and said second weight is negative, and when said correlation coefficient is positive, an amount equal to said correlation coefficient between said first weight and said second weight is added to the weight having a positive sign and an amount equal to said correlation coefficient between said first weight and said second weight is subtracted from the weight having a negative sign;
wherein in said updating step, when the sign of said first weight and the sign of said second weight is the same, and when said correlation coefficient is negative between said first weight and said second weight, an amount equal to said correlation coefficient between said first weight and said second weight is added to the weight being less than the other weight and an amount equal to said correlation coefficient between said first weight and said second weight is subtracted from the weight being greater than the other weight;
wherein in said updating step, when the sign of one of said first weight and second weight is positive and the sign of the other of said second weight and said second weight is negative, and when said correlation coefficient is negative, an amount equal to said correlation coefficient between said first weight and said second weight is subtracted from the weight having a positive sign and an amount equal to said correlation coefficient between said first weight and said second weight is added to the weight having a negative sign.

8. The method of claim 7 wherein said object comprises a plurality of attributes and the method of claim 7 is performed on said plurality of attributes.

9. The method of claim 7 further comprising the step of assigning a URMC score to said object, wherein said URMC score equals the sum of said first attribute value times said first weight and the sum of said second attribute value times the second weight.

10. A method for unsupervised ranking based on magnetic properties comprising performing the method for determining weight values of attributes as in claim 8 for a plurality of objects and ranking in numerical order said URMC scores of each of said plurality of objects.
